(19) United States
(12) Patent Application Publication
(10) Pub. No.: US 2014/0232553 A1
(43) Pub. Date: Aug. 21, 2014

(54) METHOD AND APPARATUS FOR DETERMINING LOCATION USING A SMART METER AS A LOCATION REFERENCE

(71) Applicant: QUALCOMM INCORPORATED, San Diego, CA (US)

(72) Inventors: Sai Pradeep Venkatraman, Santa Clara, CA (US); Weihua Gao, San Jose, CA (US); Amir A. Emadzadeh, Campbell, CA (US)

(73) Assignee: QUALCOMM Incorporated, San Diego, CA (US)

(21) Appl. No.: 13/769,248

(22) Filed: Feb. 15, 2013

(51) Int. Cl. G08C 17/00

(52) U.S. Cl. CPC G08C 17/00
USPC 340/870.07

(57) ABSTRACT

Methods, systems, computer-readable media, and apparatuses for using a signal transmitted by a smart meter as a location reference are presented. In one embodiment, a mobile device may receive a first signal transmitted by a smart meter and a second signal transmitted by a wireless access point. The information received may be provided to a server which may use a smart meter location to determine a location of the access point. In further embodiments, multiple measurements as well as distance measurements between a mobile device, the smart meter, and/or the access point may further be used to improve location information for the smart meter and access point.

### BACKGROUND

Aspects of the disclosure relate to computing technologies with wireless signals. In particular, aspects of the disclosure relate to systems, methods, apparatus, and computer readable media for using a signal transmitted by a smart meter as a location reference when observing other wireless signals.

Increasingly, utility companies, such as electric companies, water companies, and gas companies, are replacing traditional analog metering devices with “smart meters.” Like their traditionally analog counterparts, smart meters measure the usage of one or more services provided by a utility company. For example, a smart meter can measure the amount of electricity consumed at a house or building, such that an electric company providing power to the premises can bill the occupants for the consumed electricity. Unlike analog utility meters, however, smart meters may include one or more wireless transceivers that are used in electronically reporting usage measurements back to the utility company.

The use of such smart meters with integrated wireless transceivers may provide an environment for a number of improved devices, methods, apparatuses, and computer readable media.

### BRIEF SUMMARY

Systems, methods, apparatuses, and computer-readable media in various alternative embodiments are presented for correlating a signal transmitted by a smart meter with one or more other wireless signals.

In one potential embodiment a method comprises receiving, by a computing device, a first signal transmitted by a smart meter within a first time window; receiving, by the computing device, a second signal transmitted by a signal source such as a wireless access point, wherein the second signal is received within the first time window; and providing, by the computing device, information describing the first signal and the second signal to at least one server. While various embodiments herein use a signal transmitted by a smart meter as a reference to identify locations of wireless access points, the smart meter signals may be used as a reference to identify locations for any signal source that can be characterized by the sources signal and thereby associated with the smart meter to determine the signal source's location.

Further embodiments according to such a method may additionally comprise using, by the computing device, the first signal to determine a location of the computing device or methods where the at least one server is configured to associate the first signal with the second signal.

Further embodiments according to such a method may function where the at least one server is further configured to determine a location of the smart meter based on the first signal, or where the location of the smart meter is also determined based on account records associated with at least one utility service measured by the smart meter. Still further embodiments according to such a method may function where the location of the smart meter is determined to be an address at which the smart meter is installed; where the at least one server is further configured to determine that the wireless access point is positioned at or near the location of the smart meter; or where the information describing the first signal and the second signal includes a signal identifier and a received signal strength indication (RSSI) measurement for each of the first signal and the second signal.

Further embodiments according to such a method may additionally comprise sending a request to the smart meter prior to receiving the first signal transmitted by the smart meter, where the request is configured to cause the smart meter to transmit the first signal. Further embodiments according to such a method may function where the first signal includes usage information associated with at least one utility service measured by the smart meter.

Further embodiments according to such a method may function where the computing device includes a first component that receives the first signal transmitted by the smart meter, where the computing device includes a second component that observes the second signal transmitted by the wireless access point, and where the second component is synchronized with the first component. Still further embodiments according to such a method may function by determining a first range from the computing device to the smart meter based on a received signal strength indication (RSSI) associated with the first signal.

Further embodiments according to such a method may function where receiving the first and second signals occurs at a first time when the computing device is in a first location, with the method further comprising: receiving at the first time and the first location, by the computing device, a third signal from a second smart meter; determining a second range from the computing device to the second smart meter; and determining a second smart meter location using the second range and the first range.

Further embodiments according to such a method may additionally comprise: receiving at a second time and a second location, by the computing device, a fourth signal from the smart meter; receiving at the second time and the second location, by the computing device, a fifth signal from the second smart meter; weighting the first and fourth signals from the smart meter and the third and fifth signals from the second smart meter; and determining the second smart meter location using the weighted signals.

In one potential apparatus in accordance with an embodiment, an apparatus may comprise a memory module; a processor coupled to the memory module; and a transceiver coupled to the processor that receives a first signal transmitted by a smart meter, receives a second signal transmitted by a wireless access point where the second signal and the first signal are both received within a first time period, and provides information describing the first signal and the second signal to at least one server.

Further embodiments of such an apparatus may be structured where the apparatus further: sends a request to the smart meter via the transceiver, wherein the request is configured to cause the smart meter to transmit the first signal; receives, in response to the request and as part of the first signal, a smart meter identifier; communicates to the at least one server, the smart meter identifier; and receives, in response to communication of the smart meter identifier, location information associated with the smart meter identifier.

An alternative device according to an embodiment may comprise means for receiving a first signal transmitted by a smart meter and a second signal transmitted by a wireless access point within a first time window; means for creating an association between the smart meter and the wireless access point based on receipt of the first signal and the second signal within the first time window; and means for communicating the association between the smart meter and the wireless access point to a first server computer. Further embodiments of such a device may include means for moving from a first location where the first signal and the second signal are received to a second location; means for receiving a third signal transmitted by the smart meter and a fourth signal transmitted by the wireless access point within a second time window at the second location; and means for updating the association between the smart meter and the wireless access point using the third signal and the fourth signal.

In one potential embodiment, a non-transitory computer readable storage medium that contains computer readable instructions for performing a method that, when executed by a processor coupled to the storage medium, causes a device to execute the method comprising: receiving a first signal transmitted by a smart meter; receiving a second signal transmitted by a wireless access point, wherein the second signal is received concurrently with the first signal; and providing information describing the first signal and the second signal to at least one server.

In an additional embodiment of such a computer readable instruction medium the method may further comprise: sending a request to the smart meter, wherein the request is configured to cause the smart meter to transmit the first signal; receiving, in response to the request and as part of the first signal, a smart meter identifier; communicating to the at least one server, the smart meter identifier; and receiving, in response to communication of the smart meter identifier, location information associated with the smart meter identifier. In still further embodiments, the computer readable instruction medium may function where the method further comprises providing information describing the first signal and the second signal to the at least one server comprises communicating the information via a transceiver to the at least one server.

In one potential embodiment, a system comprises an almanac server coupled to a location server and a first mobile device; wherein the almanac server receives almanac information from the first mobile device and communicates location information derived from the almanac information to the location server; and wherein the almanac information is derived from smart meter information using a first signal received at the first mobile device from a smart meter and the almanac information is further derived from access point information using a second signal received at the first mobile device from an access point.

Additional embodiments of such a system may further comprise a first database coupled to the almanac server comprising smart meter utility information received at the first database from the smart meter via a network element, the smart meter utility information further comprising smart meter location information and smart meter identifier information. Still further embodiments of such a system may comprise a plurality of mobile devices including the first mobile device, each mobile device of the plurality of mobile devices comprising: a processor; a memory coupled to the processor; a wireless communication port coupled to the processor; a first application module that receives smart meter signals and access point signals and transmits the almanac information derived from the smart meter signals and the access point signals to the almanac server; and a second application module that receives the location information from the location server.

In an additional alternative embodiment, a method may comprise receiving, at an almanac server, information associating a first smart meter with a first wireless access point; identifying a location of the first wireless access point based a known location of the first smart meter and further based on the information associating the first smart meter with the first wireless access point; and communicating the location of the first access point to a mobile device in response to a request for location services.

In an additional alternative embodiment, a computing device may comprise means for receiving information associating a first smart meter with a first wireless access point; and means for identifying a location of the first wireless access point based a known location of the first smart meter and further based on the information associating the first smart meter with the first wireless access point.

In an additional alternative embodiment, a non-transitory computer readable storage medium that contains computer readable instructions for performing a method that, when executed by a processor coupled to the storage medium, causes a device to execute the method comprising: receiving, at an almanac server comprising the computer readable storage medium, information associating a first smart meter with a first wireless access point; identifying a location of the first access point based a known location of the first smart meter and further based on the information associating the first smart meter with the first wireless access point; and communicating the location of the first access point to a mobile device in response to a request for location services.

Further embodiments will be apparent to a person of ordinary skill in light of the additional description provided herein.

### BRIEF DESCRIPTION OF THE DRAWINGS

Aspects of the disclosure are illustrated by way of example. In the accompanying figures, like reference numbers indicate similar elements, and:

FIG. 1 illustrates a simplified diagram of a system that may incorporate one or more embodiments;

FIG. 2 illustrates a simplified diagram of an apparatus according to one or more embodiments;

FIG. 3 illustrates a simplified diagram of an apparatus according to one or more embodiments;

FIG. 4 illustrates a simplified diagram of an apparatus according to one or more embodiments;

FIG. 5 illustrates aspects of one potential method that may operate in accordance with one or more embodiments;

FIG. 6 illustrates a simplified diagram of a system that may incorporate one or more embodiments;

FIG. 7A illustrates aspects of one potential method that may operate in accordance with one or more embodiments;

FIG. 7B illustrates aspects of one potential method that may operate in accordance with one or more embodiments;

FIG. 7C illustrates aspects of one potential method that may operate in accordance with one or more embodiments; and

FIG. 8 illustrates one potential embodiment of a computing device that may be used with aspects of one or more embodiments of various systems and devices.

### DETAILED DESCRIPTION

Aspects of the disclosure relate to computing technologies with wireless signals. In particular, aspects of the disclosure relate to systems, methods, apparatus, and computer readable media for using a signal transmitted by a smart meter as a location reference when observing other wireless signals.

For example, in one potential embodiment, a smart meter attached to a residence includes a wireless transmitter. A communication device in a passing car may receive a signal from the smart meter. At the same time and location or within a small window of time and location, the communication device may receive a signal from a wireless access point. The device may then communicate with a server in a way that allows location information from the wireless access point, the smart meter, or both, to be used as a location reference. For example, the location of the smart meter may be known by the server, and the location of the access point may be identified as located relative to the smart meter. By using smart meters as reliable crowd-sourcing agents, in accordance with various aspects of the disclosure, information about observable wireless signals at various locations can be gathered and compiled more easily, accurately, and conveniently and integrated with signals from other access points.

“War driving” is a process by which wireless access points or other information may be discovered by driving with a device that listens for access point signals, and stores signal and location information. Locations may be estimated with positioning systems such as global positioning systems (GPS) and inertial navigation units within a vehicle. The above described process may, in certain embodiments, provide improved systems and methods for identifying access points by associating access points with electrical smart meters whose wireless communications may be scanned at the same time or within a small time window of the scan of access point signals. In certain embodiments, additional information may then be retrieved from a location database that contains the civic addresses of the smart meters and the unique IDs associated with smart meter signals. In some further embodiments, a civic address to geographic address converter may be used to get access point locations in alternative formats, such as a latitude, longitude, and altitude format. The use of smart meter signals in conjunction with measurement of access point signals may thus replace or supplement previously known “war driving” techniques for gathering information.

Several embodiments with reference to the appended drawings are now explained. The following description and drawings are illustrative various embodiments and are not to be construed as limiting the invention. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment.

Reference in the specification to a “same time” and “time window” refer to events that occur in close proximity to each other. For example, signals may be received from multiple sources at a device at nearly the same time, or within a small time window. In certain embodiments, a device may identify signals received within a 10 ms or 500 ms window as being received at a “same time” or as being received within a small time window. In other embodiments, a one or two second period may be considered a small time window. A time window may be any time window that allows an association to be created between a smart meter and another signal source. Similarly, for signals received within a small time window, where the device may be traveling at high speed in a vehicle, signals received in roughly the same place may be received within a window defined by the velocity of the device and the time window. Velocity of the device may be determined by a module in the device, or by communication with a vehicle in which the device is traveling.

In certain embodiment, knowledge of the data collection vehicle velocity or device velocity and heading when signals are received within a small time window may be used to more closely identify an exact relationship between a first and second signal. For example, a wireless access point signals received at a time t0 may be extrapolated to a time t1 at which the next smart meter signals is received. In this way, an additional synchronization can be achieved along with location synchronization based on knowledge of the vehicle or device movement history during a time window.

As described herein, a “smart meter” refers to a metering device with a wireless transmitter that is associated with a location. For example, smart utility meters may be used to measure the extent to which various resources are consumed at the premises. For example, one or more utility meters may measure the amount of electric power consumed at the premises, the amount of water consumed at the premises, the amount of gas consumed at the premises, and/or the like. Like their traditionally analog counterparts, smart meters may measure the usage of one or more services provided by a utility company. Unlike analog utility meters, however, smart meters may include electronic circuitry, such as one or more wireless or wireline transceivers, that allow these smart meters to electronically report usage measurements back to their respective utility company, thus avoiding the need for a person to visit the premises and manually read the meter. Notably, a smart meter may be deployed at a known location (e.g., at a particular house, building, or other relatively fixed service address) in order to measure service usage at that location.

As described herein, “wireless access point” refers to any communication point that enables wireless communications with a mobile device. Typically such communication points are connected to a broader network such as the Internet either through a land-line or other wireless access points. While in certain embodiments, a wireless access point may be transient or mobile, embodiments herein associate a wireless access point with a particular location or area. Additionally, a wireless access point may use any acceptable wireless communication method, such as communications using IEEE 802.11 wireless communication standards, Bluetooth™ communication protocols, or any other wireless communication protocols.

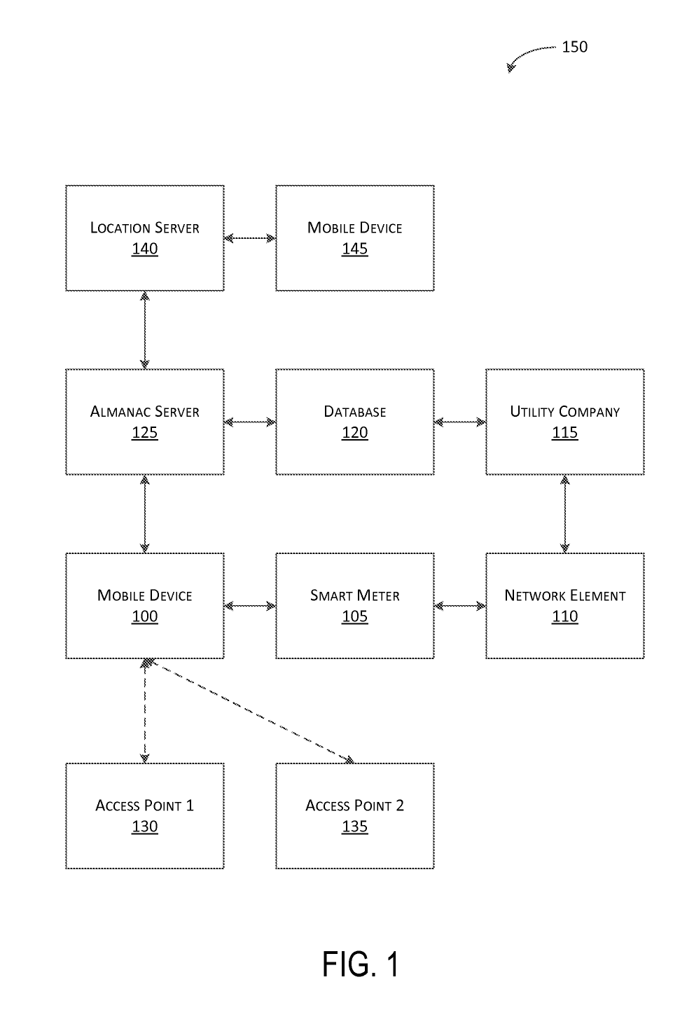

FIG. 1 illustrates an example operating environment 150 according to one potential embodiment. As seen in FIG. 1, operating environment 150 may include a mobile device 100 that is configured to observe wireless signals. In addition, operating environment 150 may include a smart meter 105 and one or more wireless access points 130 and 135. Smart meter 105 may communicate with utility company 115 via network element 110. Utility company 115 may then store information related to smart meter 105 in a database 120 that is accessible by almanac server 125. Information from both database 120 and mobile device 100 may be collected by almanac server 125. Almanac server 125 may then provide the information to location servers such as location server 140, and this information may then be used to provide location services to additional mobile devices such as mobile device 145. In various embodiments the almanac server 125 may be part of location server 140, while in other embodiments, almanac server 125 may be a separate server 125 that provides information to separate location server 140 as well as other location servers.

Almanac server 125 may be configured to receive information from various sources to be aggregated as almanac information. For example, almanac server 125 may receive information from a mobile device, analyze this information by comparing the signals observed by the mobile device with stored information originally received from one or more smart meters (and possibly other sources) about observable signals in various locations, and determine an estimated position of the mobile device based on the analysis of the signals observed by the mobile device. In other examples, the almanac server 125 may be configured to provide the stored information to a mobile device so as to allow the mobile device 100 to analyze the observed signal information and determine an estimated position for itself.

In some arrangements, mobile device 100 may observe a signal transmitted by smart meter 105, and may concurrently observe one or more signals transmitted by the one or more of wireless access points 130 and 135. In at least one arrangement, before observing the signal transmitted by smart meter 105, mobile device 100 may send a request to smart meter 105 that causes smart meter 105 to transmit the signal that is ultimately observed by mobile device 100.

Subsequently, the mobile device 100 may provide information describing the observed signals to almanac server 125, which may correlate the signals transmitted by the one or more wireless access points 130 and 135 with the signal transmitted by smart meter 105. Based on this correlation, almanac server 125 may be able to determine the location of the one or more wireless access points 130 and 135, and may subsequently assist other mobile devices that observe signals transmitted by the one or more wireless access points 130 and 135 in determining their position. In particular, almanac server 125 may assist other mobile devices observing such signals in determining that they are positioned at or close to the location at which smart meter 105 is installed. This location may be a civic address at which the smart meter 105 is installed, or alternatively, may be geographic coordinates corresponding to the civic address at which the smart meter is installed.

In some embodiments, almanac server 125 may determine the location of smart meter 105 based on information stored in a database 120 maintained by a utility company 115. The utility company 115 may, for instance, provide utility services to the house or building at which smart meter 105 is installed. In addition, utility company 115 may, for instance, communicate with smart meter 105 via a network element 110, so as to obtain usage information measured by the smart meter.

Using the correlation between the determined location of smart meter 105 and the one or more access points 130 and 135, almanac server 125 may subsequently be able to assist a second mobile device that observes signals transmitted by the one or more access points 130 and 135 in determining that the second mobile device is located at or near the location of smart meter 105 (e.g., the civic address at which the smart meter is installed, the geographic coordinates corresponding to this civic address, etc.).

These techniques allow for signals transmitted by wireless access points to be observed at various locations, and tied to information identifying such locations, without using more costly GPS-positioning equipment. Thus, these techniques may provide a cost-effective alternative to traditional, GPS-based war-driving schemes that might otherwise be used in constructing and maintaining a crowd-sourced position-assistance database. For example, location data may be based on known information combined with location measurements taken by a device. Distances between devices, access points, and smart meters may be made measuring round trip time (RTT) for communications or by using received signal strength indication (RSSI) measurements in conjunction with strength maps for a particular access point or smart meter. Additionally, these measurements may be combined with prior location and/or other network assisted location service, or by any similar such means of creating, using, and integrating location data to provide improved location services.

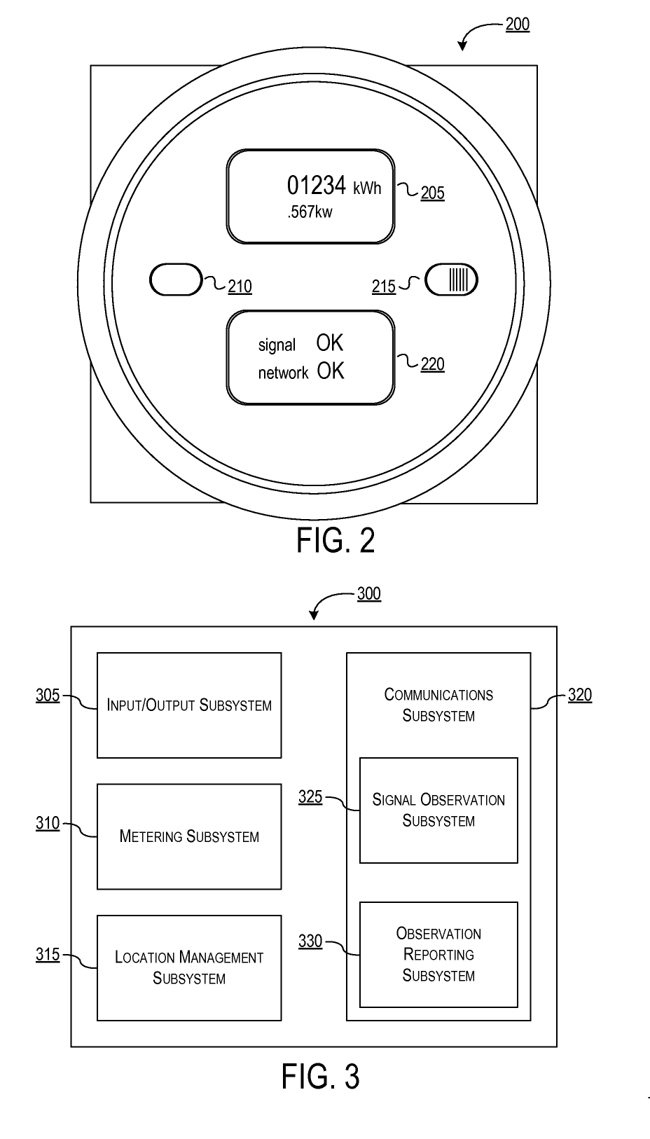

FIG. 2 illustrates an example of a smart meter 200 according to some embodiments. Smart meter 200 may be one potential implementation of smart meter 105 of FIG. 1, and may transmit a wireless signal that may be observable by mobile devices. In particular, as seen in FIG. 2, smart meter 200 may include one or more data ports (e.g., data port 210), as well as other components such as one or more display screens, such as display screens 205 and 220, and/or one or more switches or buttons (e.g., button 215).

In one or more arrangements, a smart meter, such as smart meter 200, may be installed on an exterior wall of a house, building, or other premises, or in a cabinet or closet, for instance, and the one or more components of the smart meter may allow for various types of information to be exchanged with the smart meter. For example, a user may take a reading from smart meter 200 by pressing button 215, which may turn on and/or illuminate display screens 205 and 220 of smart meter 200, and these display screens may be configured to provide various types of information. For instance, display screen 205 may display usage information measured by smart meter 200, and display screen 220 may display network and/or signal status information detected by smart meter 200. As another example, data port 210 may enable smart meter 200 to receive configuration information, which may include information specifying a current location of smart meter 200, during a configuration process, for instance. Configuration may further include access or authorization information to enable smart meter 200 to communicate with mobile devices in providing or assisting with location services and location information that may be aggregated by an almanac server.

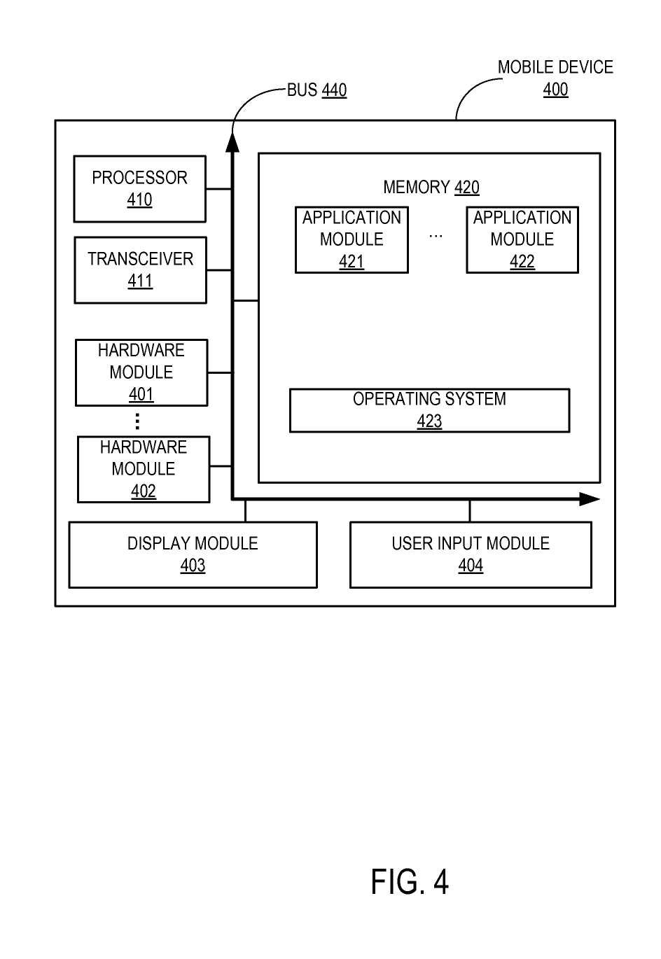

FIG. 3 further illustrates aspects of a smart meter for use with various embodiments. FIG. 3 illustrates a simplified diagram of a smart meter 300 that may incorporate one or more embodiments, and may be a system diagram for a smart meter such as smart meter 200 of FIG. 2 or smart meter 105 of FIG. 1. In the embodiment illustrated in FIG. 3, smart meter 300 includes multiple subsystems, including an input/output subsystem 305, a metering subsystem 310, a location management subsystem 315, and a communication subsystem 320, which may include a signal observation subsystem 325 and an observation reporting subsystem 330. One or more communication paths may be provided that enable the one or more subsystems to communicate with and exchange data with each other. In addition, the various subsystems illustrated in FIG. 3 may be implemented in software, hardware, or combinations thereof.

In various embodiments, smart meter 300 may include other subsystems than those shown in FIG. 3. Additionally, the embodiment shown in FIG. 3 is only one example of a system that may incorporate some embodiments, and in other embodiments, smart meter 300 may have more or fewer subsystems than those illustrated in FIG. 3, may combine two or more subsystems, or may have a different configuration or arrangement of subsystems.

In some embodiments, input/output subsystem 305 may provide one or more interfaces that enable input to be received from, and/or output to be provided to, a user of smart meter 300. For instance, input/output subsystem 305 may include one or more input devices, such as one or more buttons or keys, a mouse, a cursor, a trackball, a microphone, one or more ports (e.g., a serial port), and/or other input devices. Additionally, input/output subsystem 305 may include one or more output devices, such as one or more display screens, one or more audio speakers, and/or other output devices.

In one or more arrangements, input/output subsystem 305 may allow for smart meter 300 to be initially configured and programmed with its location information. For example, using one or more input devices and/or one or more output devices of input/output subsystem 305, a user, such as an employee of a utility company, may configure smart meter 300 to store information about the location at which smart meter 300 is deployed. Such information may be stored by location management subsystem 315, as discussed in greater detail below. In addition, the user may, for example, configure smart meter 300 to measure the amount of consumption of one or more resources, and report these measurements back to a central server. As discussed below, these measurements may be obtained via metering subsystem 310. These systems may further be coupled with external systems, such as utility company 115 or database 120 via network element 110 of FIG. 1. Such connections may enable data from location management subsystem 315 to be stored or backed-up in a database with a permanent connection to the Internet, especially if smart meter 300 has no such connection, and is only accessible via an on-site interaction with subsystem 305 or communications subsystem 120 via a mobile device.

In other arrangements, if a regular, permanent, or remotely controllable connection to a network is available, input/output subsystem 305 may allow for smart meter 300 to be configured remotely (e.g., by a utility company). For example, a user, such as a technician or other employee of a utility company, may install a smart meter that incorporates and/or otherwise embodies one or more aspects of smart meter 300 at a particular premises. Rather than having the technician enter the address of the premises into smart meter 300, the address of the premises at which the smart meter is installed may be provided to smart meter 300 by one or more remote users, who may, for instance, be located at a central office of the utility company. These users may, for instance, provide the address of the premises to the smart meter, based on a unique identifier corresponding to the smart meter. In these arrangements, the smart meter and/or smart meter 300 may observe one or more wireless signals at its installation location. Subsequently, the smart meter and/or smart meter 300 may report information describing these observations, along with its unique identifier, up to an almanac server in order to support position assistance functionalities, as discussed in greater detail below.

In some embodiments, metering subsystem 310 may enable smart meter 300 to measure usage of one or more consumable utility services. For example, metering subsystem 310 may include one or more sensors, gauges, and/or other measurement devices that allow for various types of measurements. For instance, metering subsystem 310 may allow smart meter 300 to measure an amount of electric power consumed (e.g., in kilowatt-hours) at a premises at which smart meter 300 is located, an amount of water consumed at the premises at which smart meter 300 is located, and/or an amount of gas consumed at the premises at which smart meter 300 is located. In addition, metering subsystem 310 may store this usage information to facilitate reporting of the usage information to a central server, as discussed above.

In some embodiments, location management subsystem 315 may enable smart meter 300 to determine and/or store information about a current location of smart meter 300. For example, location management subsystem 315 may include one or more location determination components (e.g., a Global Positioning System (GPS) receiver) that enable smart meter 300 to determine its current location. Additionally or alternatively, location management subsystem 315 may include one or more storage modules that enable smart meter 300 to store information about its current location. Such information may, for instance, be determined using one or more location determination components included in location management subsystem 315. Additionally or alternatively, information related to the current location of smart meter 300 may be determined during configuration of smart meter 300.

For example, in some instances, a user may provide input specifying, during a configuration process, a particular location as being the current location of smart meter 300, and location management subsystem 315 may store this location. In one or more arrangements, the location information stored by location management subsystem 315 may include various types of location information, including a street address corresponding to the location of smart meter 300, geographic coordinates of the location of smart meter 300, and/or error values associated with the location of smart meter 300. Location management subsystem 315 also may store additional assistance information from which the location of smart meter 300 may be determined, including an account number (e.g., associated with the service(s) being measured by metering subsystem 310) and/or a smart meter identifier associated with smart meter 300. For example, location management subsystem 315 may store a unique identifier corresponding to a smart meter that may incorporate and/or otherwise embody one or more aspects of smart meter 300. Such a unique identifier may, for instance, be used to indirectly determine the installation location of the smart meter (e.g., via a remote entity that maintains location information for various smart meters in association with their respective unique identifiers).

In some embodiments, communications subsystem 320 may enable smart meter 300 to communicate electronically with one or more other devices. Communications subsystem 320 may include one or more wired and/or wireless interfaces via which smart meter 300 may send and/or receive information. Examples of wired interfaces that may be included in communications subsystem 320 include one or more Ethernet interfaces, one or more power-line communications interfaces, one or more serial port interfaces, and/or other wired communications interfaces. Examples of wireless interfaces that may be included in communications subsystem 320 include one or more cellular communications interfaces (e.g., one or more CDMA interfaces, WCDMA interfaces, GSM interfaces, etc.), one or more WLAN interfaces (e.g., one or more IEEE 802.11 interfaces), and/or other wireless communications interfaces (e.g., Bluetooth, ZigBee, etc.).

In one or more arrangements, communications subsystem 320 may enable smart meter 300 to observe wireless signals at the location at which smart meter 300 is deployed, and report information about the observed signals to a central server, such as a signal almanac server. Along these lines, communications subsystem 320 may include a signal observation subsystem 325 and an observation reporting subsystem 330.

In some embodiments, signal observation subsystem 325 may cause smart meter 300 and/or communications subsystem 320 to observe one or more wireless signals at the location at which smart meter 300 is deployed. In observing wireless signals, signal observation subsystem 325 may, for instance, enable one or more wireless interfaces provided by communications subsystem 320, scan for and receive one or more wireless signals that are capable of being received at the location, and record and store information describing various properties of the received wireless signals, as well as any other information that may be desirable, such as the time and/or date at which the signals were received. Any and/or all of this information may subsequently be reported to a signal almanac server, for instance, by observation reporting subsystem 330.

In particular, in some embodiments, observation reporting subsystem 330 may cause smart meter 300 and/or communications subsystem 320 to report information about the observed signals to a signal almanac server, which may access, store, and/or maintain a signal almanac database in which information about the wireless signals that are observable at various locations may be stored. In reporting information about the observed signals to a signal almanac server, observation reporting subsystem 330 may, for instance, establish a data connection with the signal almanac server and subsequently send one or more data messages to the signal almanac server. In some embodiments, one or more of these messages sent by observation reporting subsystem 330 may be a signal observations message, as discussed in greater detail below. Additionally or alternatively, observation reporting subsystem 330 may, in some instances, cause smart meter 300 and/or communications subsystem 320 to indirectly report information about the observed signals to an almanac server (e.g., by reporting information about the observed signals to the almanac server via an entity or element controlled by a utility company that installed and/or otherwise deployed system 300).

In further embodiments, signal observation system may include an input control for receiving a request for the smart meter's unique identifier from a passing mobile device. The input control may comprise an alphanumeric password, or an identifier that indicates that the mobile device is authorized to receive information stored by the smart meter. Additional information may further be provided by the smart meter, such as smart meter location information, previous mobile device communications with the smart meter, or any other such information that may be stored at the smart meter.

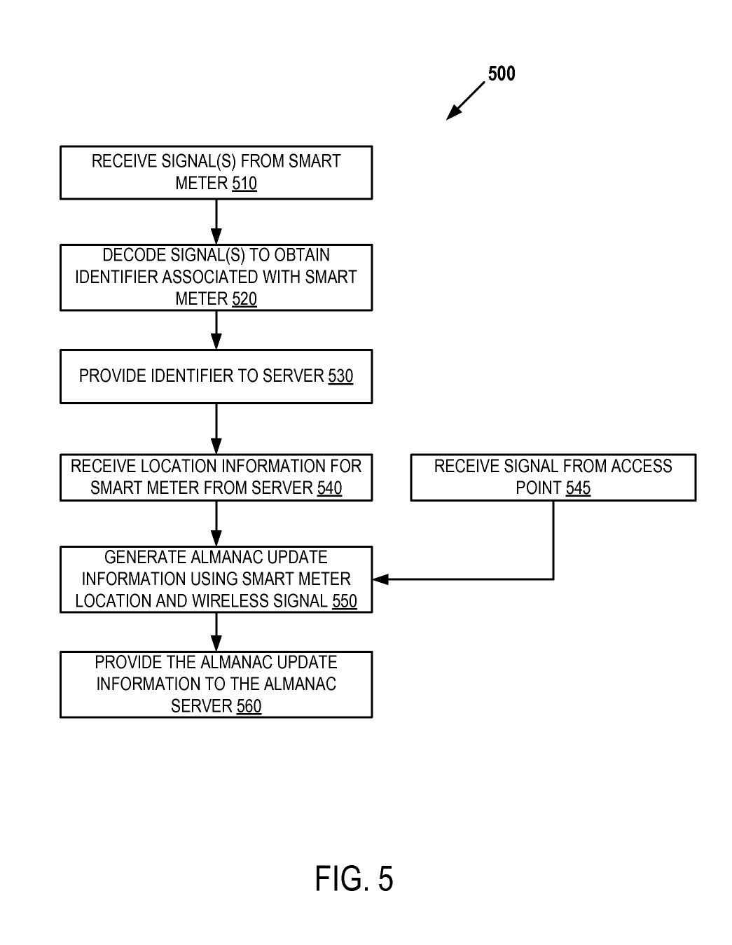

FIG. 4 is block diagram illustrating one potential embodiment of a mobile device that may be used in conjunction with embodiments described herein. The system may be a mobile device 400, which may be any mobile device such as a smart phone, cellular phone, personal digital assistant, tablet computer, personal media player as well as any other type of portable electronic device offering similar or combined functionality. It should be appreciated that device 400 may also include tactile buttons, a power device (e.g., a battery), as well as other components typically associated with a portable electronic device. Accordingly, FIG. 4 is not to be construed as limiting because some components are omitted.

In the embodiment shown at FIG. 4, device 400 includes processor 410 configured to execute instructions for performing operations at a number of components and can be, for example, a general-purpose processor or microprocessor suitable for implementation within a portable electronic device. Processor 410 is communicatively coupled with a plurality of components within mobile device 400. To realize this communicative coupling, processor 410 may communicate with the other illustrated components across a bus 440. Bus 440 can be any subsystem adapted to transfer data within mobile device 400. Bus 440 can be a plurality of computer buses and include additional circuitry to transfer data.

Memory 420 may be coupled to processor 410. In some embodiments, memory 420 offers both short-term and long-term storage and may in fact be divided into several units. Memory 420 may be volatile, such as static random access memory (SRAM) and/or dynamic random access memory (DRAM) and/or non-volatile, such as read-only memory (ROM), flash memory, and the like. Furthermore, memory 420 can include removable storage devices, such as secure digital (SD) cards. Thus, memory 420 provides storage of computer readable instructions, data structures, program modules, and other data for mobile device 400. In some embodiments, memory 420 may be distributed into different hardware modules.

In some embodiments, memory 420 stores a plurality of application modules 421-422. Application modules 421-422 contain particular instructions to be executed by processor 410. Memory 420 can store any number of application modules. A respective one of application modules 421-422 can be, for example, a calendar application, a geo-fencing application, a power management application, a smart alert application, a social media application (e.g., Twitter™ or Facebook™), or any application-type module having instructions to be executed by processor 410.

In some embodiments, memory 420 includes an operating system 423. Operating system 423 may be operable to initiate the execution of the instructions provided by application modules 421-422 and/or manage hardware modules 401-402. Operating system 423 may be adapted to perform other operations across the components of device 400 including threading, resource management, data storage control and other similar functionality.

In some embodiments, mobile device 400 includes a plurality of hardware modules 401-402. Each of hardware modules 401-402 is a physical module within device 400. However, while each of hardware modules 401-402 is permanently configured as a structure, a respective one of hardware modules 401-402 may be temporarily configured to perform specific functions or temporarily activated. A common example is an application module that may program a camera module (i.e., hardware module) for shutter release and image capture. A respective one of hardware modules 401-402 can be, for example, an accelerometer, a Wi-Fi transceiver, a satellite navigation system receiver (e.g., a GPS module), a pressure module, a temperature module, an audio output and/or input module (e.g., a microphone), a camera module, a proximity sensor, an alternate line service (ALS) module, a capacitive touch sensor, a near field communication (NFC) module, a Bluetooth transceiver, a cellular transceiver, a magnetometer, a gyroscope, an inertial sensor (e.g., a module the combines an accelerometer and a gyroscope), an ambient light sensor, a relative humidity sensor, or any other similar module operable to provide sensory output and/or receive sensory input. In some embodiments, one or more functions of the hardware modules 401-402 may be implemented in software.

Device 400 may include a component such as transceiver 411. Transceiver 411 may be configured to receive signals from various devices such as smart meters and access points and configured to transmit signals to another entity such as almanac server 125 or location server 140.

In certain embodiments, hardware modules and/or application modules may be specifically directed toward receiving simultaneous signals from wireless access points and smart meters, and using such signals to create and update almanac and location information in association with almanac and location servers. In one embodiment, for example, an application module 421 may be a downloadable set of instructions that include codes for initiating an interaction with a smart meter, specific addresses for communicating with an appropriate almanac server, and further instructions for processing RSSI, RTT, or other measurements associated with a distance between the mobile device, and an access point or smart meter.

In addition to hardware modules 401-402 and application modules 421-422, mobile device 400 may have a display module 403 and a user input module 404. Display module 403 graphically presents information from device 400 to the user. This information may be derived from one or more application modules 421-422, one or more hardware modules 401-402, a combination thereof, or any other suitable means for resolving graphical content for the user (e.g., by operating system 424). Display module 403 can be liquid crystal display (LCD) technology, light emitting polymer display (LPD) technology, or some other display technology. In some embodiments, display module 403 is a capacitive or resistive touch screen and may be sensitive to haptic and/or tactile contact with a user. In such embodiments, the display module 403 can comprise a multi-touch-sensitive display.

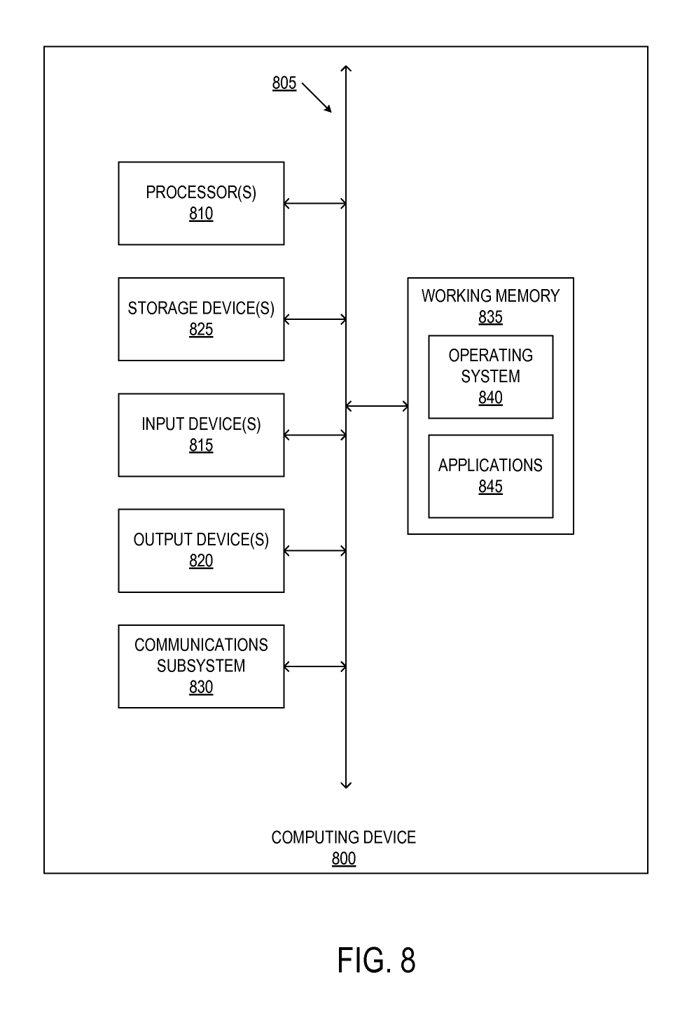

Additional embodiments of a mobile device may further comprise various portions of computing devices as are detailed below with respect to FIG. 8.

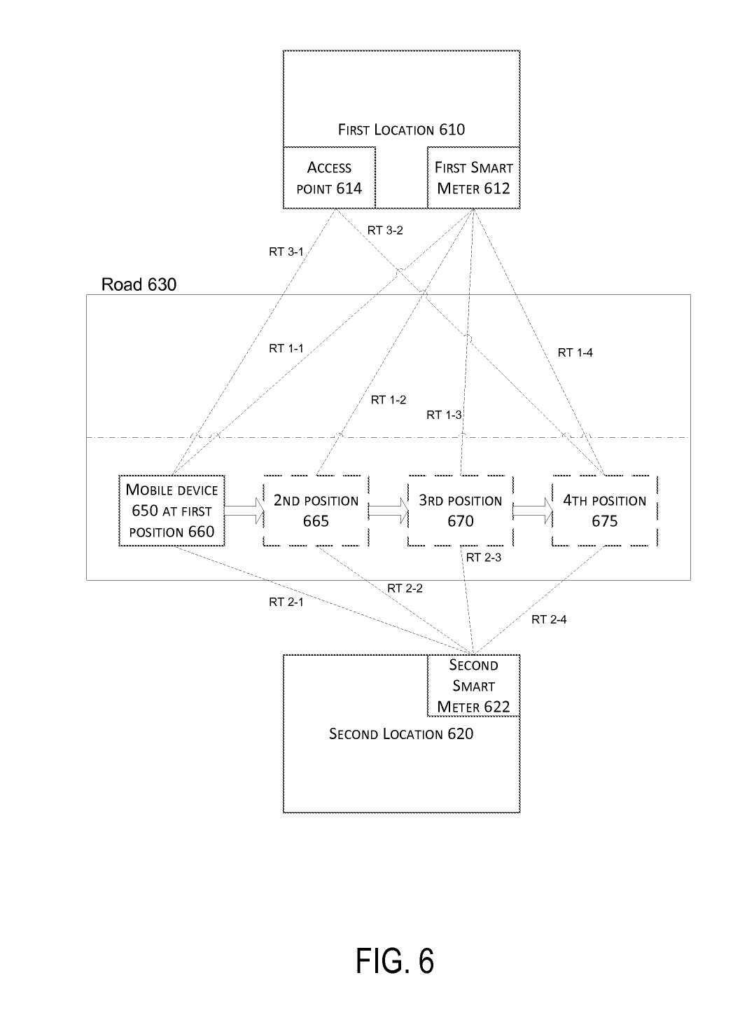

FIG. 5 describes a method 500 which may be associated with the systems and devices described above to implement one potential method of using a wireless signal from a smart meter as a location reference when observing other signals.

In 510, one or more signals are received from a smart meter. These signals may be received at a mobile device such as mobile device 400 of FIG. 4, or may be received by any capable device. In 520, the signal received from the smart meter is decoded to obtain a unique identifier associated with the particular smart meter. In 530, the identifier is provided to a server 530, which may be an almanac server, a location server, a database server, or any server capable of using the information from the identifier. In 540, location information for smart meter is received from the server. This location information may identify an address associated with the smart meter, or may specifically identify a location of the smart meter inside of an address.

In 545, a signal is received from an access point. While contact with either the smart meter or the access point may occur first, the device that receives both signals must have some way of associating the access point with the smart meter. The simplest association is that signals from both are received by a device at the same time or within a small time window. In various alternative embodiments, an inertial movement sensor within the device or some other means for relating the two signals may be used. In 550, then, signals from both the access point and the smart meter have been received, and the almanac information is generated using these signals. While this almanac information may take a variety of forms, the almanac information may essentially provide a location for the access point based on the known location information for the smart meter. In 550, the almanac information is provided to the almanac server 560.

In various embodiments, the almanac information may then be used in different ways. In one potential embodiment, a second mobile device which is accessing a network via the access point may receive location information which was derived from the almanac information. This may be directly from the almanac server, or may be from a location server which provides location services, where the location information is created or supplemented by the almanac server. This enables the second mobile device to access location information without communicating with the smart meter. This almanac information may further be used to locate additional access points or smart meters. For example, if a second access point or second smart meter is too far away from the first smart meter for the second access point signals to be received within an acceptable time window from receipt of the smart meter signals, but is within range of the first access point, then a location for the second access point or second smart meter may be derived in a chain from the first smart meter location via the access point location.

In further alternative embodiments of a method similar to the method of FIG. 5, rather than receiving location information from the smart meter at a device, the device may simply communicate almanac information to an almanac server indicating a proximity of the access point and the smart meter. Location information from the smart meter may then be associated with the access point at the almanac server. This enables the almanac server to be updated with relative information from the device, without the device having absolute location information, or address location information for either the access point or the smart meter.

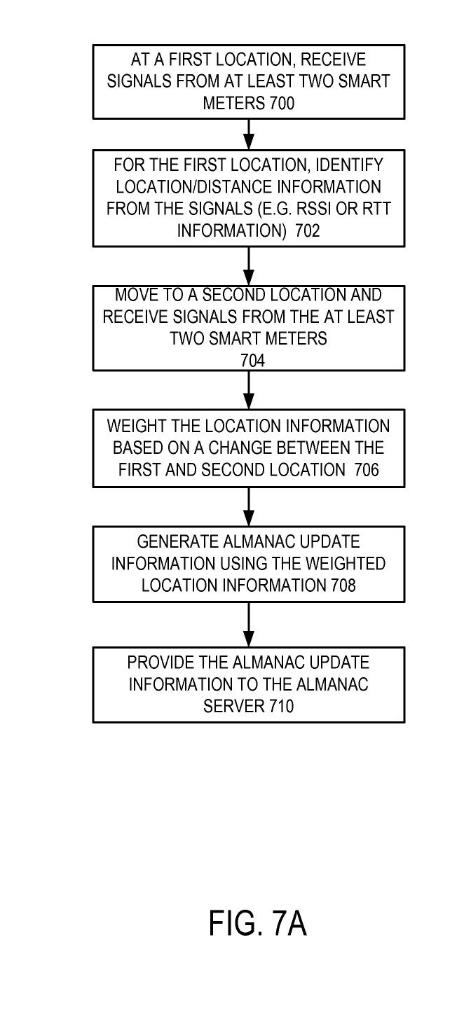

FIG. 6 describes an environment in which additional detailed location information may be derived from a system using smart meter information. FIG. 6 includes first location 610, second location 620, road 630, and mobile device 650. Location 610 includes access point 614 and first smart meter 612. Second location 620 includes second smart meter 622. The smart meters here may thus be associated with a building or utility use at each location where the smart meter is recording information for utility usage at the location. Mobile device 650 moves along the road during one potential embodiment, from first position 660, to second position 665, to third position 670, to fourth position 675. Signals between mobile device 650 and access point 614, first smart meter 612, and second smart meter 622 are shown. RT 1-1 through RT 1-4 are signals between mobile device 650 and smart meter 612 at different positions as shown. RT 2-1 through 2-4 are signals between mobile device 650 and second smart meter 622 at different positions as shown. RT 3-1 and 3-2 are signals between mobile device 650 and access point 614 as shown.

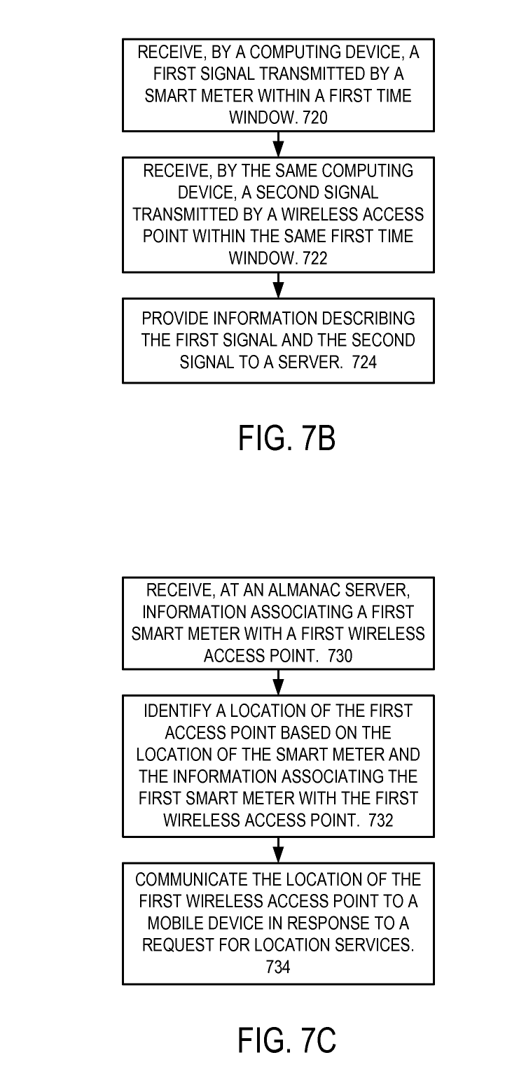

FIG. 7A describes an alternative method according to one embodiment, and will be described in the context of the environment shown in FIG. 6. In 700, at a first position 660, mobile device 650 receives signals from smart meters 610 and 620. In 702, as part of communications at first position 660, mobile device 650 uses RT 1-1 communications with the first smart meter to identify location and/or distance information using the signal. This location information may comprise received signal strength indication (RSSI) information or round trip time (RTT) information which may be used to establish distance information between mobile device 650 and first smart meter 610. Similarly, as part of 700, mobile device 650 uses RT 2-1 to establish distance information with the second smart meter. In additional embodiments, any number of smart meters may have distance information determined as part of this step. Additionally, while RT 1-1 and RT 2-1 are shown as occurring at identical position 660, in alternative embodiments, these communications may occur within slightly different positions. For example, if mobile device 650 is in motion during the measurements, the position may be slightly different for each measurement if the RT 1-1 and RT 2-1 are performed serially and not in parallel.

In 704, then mobile device 650 moves to second position 665. At second position 665, signal RT 1-2 is received from the first smart meter 610 and signal RT 2-2 is received from the second smart meter 620. This may further involve distance determination using RSSI and/or RTT measurements similar to those from 702.

In 706, the differences between the distance information measured at the first position 660 and those measured at the second position 665 are used to weight the location information for each smart meter, and for mobile device 650. This determination of distance differences and weighting may be repeated any number of times, including at position 670 and position 675 using the signals shown. These differences may further be used to improve the weighting of the location information gathered by mobile device 650.

In 708, almanac update information using the weighted location information and/or the distance measurements is created, and in 710, this information is provided to almanac server 710. In various alternative embodiments, the method of FIG. 7 may be performed simultaneously, or in partial combination with the method of FIG. 5, so that measurements for an access point also occur at the same time or within the same small time window that the weighted measurements for the smart meters are taken. As shown in FIG. 6, communication from mobile device 650 to access point 614 may occur via RT 3-1, with similar RTT and/or RSSI measurements take as mobile device 650 moves from first position 660 to fourth position 675. This information may further be incorporated into almanac information and communicated to an almanac server. Also, as described above, in certain embodiments, measurements may be taken on the RT paths as shown, and the raw measurement data may be sent to an almanac server, with any computations, weighting, and correlation between locations made at the almanac server.

FIG. 7B further describes one potential embodiment. In 720, computing device receives a first signal transmitted by a smart meter within a first time window or time period. In 722, the computing device receives a second signal transmitted by a wireless access point within the same first time window. These signals may be received at the same time, or essentially a small time window such that the position of the computing device does not change substantially during the first time window for the purposes of determining a relative location between the wireless access point and the smart meter. This may mean that the devices are near each other, or it may mean that the distance is such that it may be quantified so a general location of one can be determined from the location of the other, even if that location determination is not as accurate as information for the other transmission source. Finally, in 724, information describing the first signal and the second signal are provided to a server. This may be information associating the smart meter and the wireless access point, or it may be information related to the first and second signals, including information indicating that both signals were received within the first time window.

FIG. 7C describes an additional embodiment. Such an embodiment may complement the embodiment of FIG. 7B, or may be implemented separately from the embodiment of FIG. 7B. In 730, an almanac server receives information associating a first smart meter with a first wireless access point. Just as above, this may be information derived from signals received within a time window from the smart meter and the access point, included an analysis of relative locations that were further refined by multiple measurements. Alternatively, this may simply be a message indicating that signals from a smart meter and a wireless access point were received at a computing device within a specified time frame.

In 732, a location of the first access point is identified, based at least in part on the location of the smart meter and receipt of the information associating the smart meter with the first wireless access point. This may be done, for example, by retrieving an address associated with the smart meter from a database and using the association to identify an area for the smart meter relative to the address as identified by the associating information. The wireless access point thus need not be exactly at the same location as the smart meter or a smart meter address, but may be adjacent, across, or otherwise near to the smart meter in addition to potentially being co-located with the smart meter.

Finally, in 734, the location of the first wireless access point is communicated to a mobile device in response to a request for location services. Such a request and response may occur in a variety of ways. In one embodiment, a mobile device may have a contract or relationship with a location service provider that receives location information from the almanac server. When the mobile device identifies the wireless access point, it may send an identifier to the location service, and receive back the location of the first wireless access point that was determined using the associating with the smart meter. In other embodiments, this information may be communicated to a wireless device in other ways. For example, the location may be stored at the wireless access point, and communicated to users that connect to the wireless access point.

FIG. 8 illustrates an example of a computing system in which one or more embodiments may be implemented. A computer system as illustrated in FIG. 8 may be incorporated as part of the previously described computerized devices in FIGS. 1-4 and 6. Any component of a system according to various embodiments may include a computer system as described by FIG. 8, including transceivers, smart meter modules, mobile devices, servers, and processing devices FIG. 8 provides a schematic illustration of one embodiment of a computer system 800 that can perform the methods provided by various other embodiments, as described herein, and/or can function as the almanac server 125, database 120, mobile device 100, smart meter 105, utility company 115, location server 140, or mobile device 145 of FIG. 1. FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805 (or may otherwise be in communication, as appropriate). The hardware elements may include one or more processors 810, including without limitation one or more general-purpose processors and/or one or more special-purpose processors (such as digital signal processing chips, graphics acceleration processors, and/or the like); one or more input devices 815, which can include without limitation a mouse, a keyboard and/or the like; and one or more output devices 820, which can include without limitation a display device, a printer and/or the like.

The computer system 800 may further include (and/or be in communication with) one or more non-transitory storage devices 825, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 800 might also include a communications subsystem 830, which can include without limitation a modem, a network card (wireless or wired), an infrared communication device, a wireless communication device and/or chipset (such as a Bluetooth™ device, an 802.11 device, a Wi-Fi device, a WiMax device, cellular communication facilities, etc.), and/or similar communication interfaces. The communications subsystem 830 may permit data to be exchanged with a network (such as the network described below, to name one example), other computer systems, and/or any other devices described herein. In many embodiments, the computer system 800 will further comprise a non-transitory working memory 835, which can include a RAM or ROM device, as described above.

The computer system 800 also can comprise software elements, shown as being currently located within the working memory 835, including an operating system 840, device drivers, executable libraries, and/or other code, such as one or more application programs 845, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 825 described above. In some cases, the storage medium might be incorporated within a computer system, such as computer system 800. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, an activity selection subsystem configured to provide some or all of the features described herein relating to the selection of activities by a context assistance server 140 can comprise hardware and/or software that is specialized (e.g., an application-specific integrated circuit (ASIC), a software method, etc.) or generic (e.g., processor(s) 810, applications 845, etc.) Further, connection to other computing devices such as network input/output devices may be employed.

Some embodiments may employ a computer system (such as the computer system 800) to perform methods in accordance with the disclosure. For example, some or all of the procedures of the described methods may be performed by the computer system 800 in response to processor 810 executing one or more sequences of one or more instructions (which might be incorporated into the operating system 840 and/or other code, such as an application program 845) contained in the working memory 835. Such instructions may be read into the working memory 835 from another computer-readable medium, such as one or more of the storage device(s) 825. Merely by way of example, execution of the sequences of instructions contained in the working memory 835 might cause the processor(s) 810 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 800, various computer-readable media might be involved in providing instructions/code to processor(s) 810 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 825. Volatile media include, without limitation, dynamic memory, such as the working memory 835. Transmission media include, without limitation, coaxial cables, copper wire and fiber optics, including the wires that comprise the bus 805, as well as the various components of the communications subsystem 830 (and/or the media by which the communications subsystem 830 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800. These signals, which might be in the form of electromagnetic signals, acoustic signals, optical signals and/or the like, are all examples of carrier waves on which instructions can be encoded, in accordance with various embodiments.

The communications subsystem 830 (and/or components thereof) generally will receive the signals, and the bus 805 then might carry the signals (and/or the data, instructions, etc. carried by the signals) to the working memory 835, from which the processor(s) 805 retrieves and executes the instructions. The instructions received by the working memory 835 may optionally be stored on a non-transitory storage device 825 either before or after execution by the processor(s) 810.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of various embodiments. Rather, the preceding description of the embodiments will provide those skilled in the art with an enabling description for implementing embodiments. Various changes may be made in the function and arrangement of elements without departing from the spirit and scope of various embodiments.

Also, some embodiments were described as processes depicted in a flow with process arrows. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application various embodiments. Also, a number of steps may be undertaken before, during, or after the above elements are considered. Accordingly, the above description does not limit the scope of the disclosure.

What is claimed is:

1. A method comprising:
receiving, by a computing device, a first signal transmitted by a smart meter within a first time window;
receiving, by the computing device, a second signal transmitted by a wireless access point, wherein the second signal is received within the first time window; and
providing, by the computing device, information describing the first signal and the second signal to at least one server.

2. The method of claim 1, further comprising:
using, by the computing device, the first signal to determine a location of the computing device.

3. The method of claim 1, wherein the computing device is configured to associate the first signal with the second signal.

4. The method of claim 3, wherein the computing device is further configured to determine a location of the smart meter based on the first signal and determine a location of the wireless access point based on the location of the smart meter; and
wherein the information describing the first signal and the second signal comprises the location of the smart meter and the location of the wireless access point.

5. The method of claim 4, wherein the location of the smart meter is also determined based on account records associated with at least one utility service measured by the smart meter.

6. The method of claim 4, wherein the location of the smart meter is determined to be an address at which the smart meter is installed.

7. The method of claim 4, wherein the computing device is further configured to determine a location of a second wireless access point using a third signal received from the second wireless access point, the location of the smart meter and the location of the wireless access point.

8. The method of claim 4, wherein the information describing the first signal and the second signal includes a signal identifier and a received signal strength indication (RSSI) measurement for each of the first signal and the second signal; and
wherein the location of the wireless access point is calculated by the computing device using the RSSI measurement for the first signal and the second signal.

9. The method of claim 1, further comprising:
prior to receiving the first signal transmitted by the smart meter, sending a request to the smart meter, wherein the request is configured to cause the smart meter to transmit the first signal.

10. The method of claim 1, wherein the first signal includes usage information associated with at least one utility service measured by the smart meter.

11. The method of claim 1,
wherein the computing device includes a first component that receives the first signal transmitted by the smart meter,
wherein the computing device includes a second component that observes the second signal transmitted by the wireless access point, and
wherein the second component is synchronized with the first component.

12. The method of claim 1, further comprising:
determining a first range from the computing device to the smart meter based on a received signal strength indication (RSSI) associated with the first signal.

13. The method of claim 12 wherein receiving the first and second signals occurs at a first time when the computing device is in a first location, the method further comprising:
receiving at the first time and the first location, by the computing device, a third signal from a second smart meter;
determining a second range from the computing device to the second smart meter; and
determining a second smart meter location using the second range and the first range.

14. The method of claim 13 wherein determining the second smart meter location further comprises:
receiving at a second time and a second location, by the computing device, a fourth signal from the smart meter;
receiving at the second time and the second location, by the computing device, a fifth signal from the second smart meter;
weighting the first and fourth signals from the smart meter and the third and fifth signals from the second smart meter; and
determining the second smart meter location using the weighted signals.

15. An apparatus comprising:
a processor; and
a transceiver coupled to the processor, wherein the transceiver is configured to:
receive a first signal transmitted by a smart meter;
receive a second signal transmitted by a wireless access point where the second signal and the first signal are both received within a first time period; and
provides information describing the first signal and the second signal to at least one server.

16. The apparatus of claim 15 wherein the transceiver is further configured to:
send a request to the smart meter, wherein the request is configured to cause the smart meter to transmit the first signal;
receive, in response to the request and as part of the first signal, a smart meter identifier;
communicate to the at least one server, the smart meter identifier; and
receive, in response to communication of the smart meter identifier, location information associated with the smart meter identifier.

17. The apparatus of claim 15 wherein the processor is configured to associate the first signal with the second signal.

18. The apparatus of claim 15 wherein the processor is further configured to calculate a received signal strength indication (RSSI) measurement for each of the first signal and the second signal; and
wherein the processor is further configured to calculate a location of the wireless access point using the RSSI measurement for the first signal and the second signal.

19. A device comprising:
means for receiving a first signal transmitted by a smart meter and a second signal transmitted by a wireless access point within a first time window; and
means for providing information describing the first signal and the second signal to at least one server.

20. The device of claim 19 further comprising:
means for determining a first range from the device to the smart meter based on a received signal strength indication (RSSI) associated with the first signal.
means for receiving within the first time window and a first location, by the device, a third signal from a second smart meter;
means for determining a second range from the device to the second smart meter; and
means for determining a second smart meter location using the second range and the first range.
means for receiving at a second time and a second location, by the device, a fourth signal from the smart meter;
means for receiving at the second time and the second location, by the device, a fifth signal from the second smart meter;
means for weighting the first and fourth signals from the smart meter and the third and fifth signals from the second smart meter; and
means for determining the second smart meter location using the weighted signals.

21. The device of claim 19 further comprising means for associating the first signal with the second signal.

22. The device of claim 21 further comprising means for calculating a location of the wireless access point from the first signal and the second signal.

23. A non-transitory computer readable storage medium that contains computer readable instructions for performing a method that, when executed by a processor coupled to the storage medium, causes a device to execute the method comprising:
receiving a first signal transmitted by a smart meter;
receiving a second signal transmitted by a wireless access point, wherein the second signal is received concurrently with the first signal; and
providing information describing the first signal and the second signal to at least one server.

24. The computer readable storage medium of claim 23, wherein the method further comprises:
sending a request to the smart meter, wherein the request is configured to cause the smart meter to transmit the first signal;
receiving, in response to the request and as part of the first signal, a smart meter identifier;
communicating to the at least one server, the smart meter identifier; and
receiving, in response to communication of the smart meter identifier, location information associated with the smart meter identifier.

25. The computer readable storage medium of claim 23, wherein the method further comprises:
using, by the device, the first signal to determine a location of the device.

26. The computer readable storage medium of claim 23, wherein the method further comprises:
associating the first signal with the second signal at the device.

27. The computer readable storage medium of claim 23, wherein the method further comprises:
determining by the device, a location of the smart meter; and
determining by the device, a location of the wireless access point based on the location of the smart meter

28. A system comprising:
an almanac server coupled to a location server and a first mobile device;
wherein the almanac server receives almanac information from the first mobile device and communicates location information derived from the almanac information to the location server; and
wherein the almanac information is derived from smart meter information using a first signal received at the first mobile device from a smart meter and the almanac information is further derived from wireless access point information using a second signal received at the first mobile device from a wireless access point.

29. The system of claim 28 further comprising:
a first database coupled to the almanac server comprising smart meter utility information received at the first database from the smart meter via a network element, the smart meter utility information further comprising smart meter location information and smart meter identifier information.

30. The system of claim 29 further comprising a plurality of mobile devices including the first mobile device, each mobile device of the plurality of mobile devices comprising:
a processor;
a memory coupled to the processor;
a wireless communication port coupled to the processor;
a first application module that receives smart meter signals and access point signals and transmits the almanac information derived from the smart meter signals and the access point signals to the almanac server; and
a second application module that receives the location information from the location server.

31. A method comprising:
receiving, at an almanac server, information associating a first smart meter with a first wireless access point;
identifying a location of the first wireless access point based on a known location of the first smart meter and further based on the information associating the first smart meter with the first wireless access point; and
communicating the location of the first wireless access point to a mobile device in response to a request for location services.

32. The method of claim 31 wherein identifying the location of the first wireless access point based on the known location comprises accessing a utility company database to identify the known location of the first smart meter.

33. The method of claim 31 wherein communicating the location of the first wireless access point to the mobile device comprises:
communicating the location of the first wireless access point from the almanac server to a location server as part of a transfer of a plurality of wireless access point locations from the almanac server to the location server; and
communicating the location of the first wireless access point to the mobile device from the location server to the mobile device from the location server.

34. A computing device comprising:
means for receiving information associating a first smart meter with a first wireless access point; and
means for identifying a location of the first wireless access point based a known location of the first smart meter and further based on the information associating the first smart meter with the first wireless access point.

35. The computing device of claim 34 further comprising:
means for accessing a utility company database to identify the known location of the first smart meter.

36. The computing device of claim 35 further comprising:
means for updating the location of the first wireless access point based on additional information associating the first smart meter with the first wireless access point.

37. A non-transitory computer readable storage medium that contains computer readable instructions for performing a method that, when executed by a processor coupled to the storage medium, causes a device to execute the method comprising:
receiving, at an almanac server comprising the computer readable storage medium, information associating a first smart meter with a first wireless access point;
identifying a location of the first wireless access point based on a known location of the first smart meter and further based on the information associating the first smart meter with the first wireless access point; and
communicating the location of the first wireless access point to a mobile device in response to a request for location services.

38. The non-transitory computer readable storage medium of claim 37 wherein the information associating the first smart meter with the first wireless access point comprises round trip time information.

39. The non-transitory computer readable storage medium of claim 38 wherein identifying the location of the first wireless access point based on the known location of the first smart meter and further based on the information associating the first smart meter with the first wireless access point comprises calculating a relative location of the first wireless access point in relation to the known location of the first smart meter using the round trip time information.
